(19) United States
(12) Patent Application Publication
(10) Pub. No.: US 2014/0281780 A1
(43) Pub. Date: Sep. 18, 2014

(54) ERROR DETECTION AND RECOVERY OF TRANSMISSION DATA IN COMPUTING SYSTEMS AND ENVIRONMENTS

(71) Applicant: Teradata Corporation, Dayton, OH (US)

(72) Inventors: Jeremy L. Branscome, Santa Clara, CA (US); Liuxi Yang, Sunnyvale, CA (US); James Patrick Crowley, Santa Cruz, CA (US)

(73) Assignee: Teradata Corporation, Dayton, OH (US)

(21) Appl. No.: 14/211,043

(22) Filed: Mar. 14, 2014

Related U.S. Application Data
(60) Provisional application No. 61/788,086, filed on Mar. 15, 2013.

(51) Int. Cl. G06F 11/10; H04L 1/08

(52) U.S. Cl. CPC G06F 11/10; H04L 1/08
USPC 714/748; 714/807

(57) ABSTRACT

Errors that can be detected as a result of the mapping of transmission data from its physical form back to its logical form can be considered in addition to the errors detected by using an error detection technique (e.g., a conventional CRC technique), thereby allowing fewer error detection/recovery bits (error recovery data or bits) to be used as would be possible by using the error detection technique alone. In other words, less error recovery data would be needed to achieve a given level accuracy using conventional techniques. As a result, overhead associated with adding error detection/recovery bits can be reduced.

### CROSS-REFERENCE TO RELATED PATENT APPLICATIONS

This application takes priority from the Provisional U.S. Patent Application No. 61/788,086, entitled: “ERROR DETECTION AND RECOVERY ON A HIGH SPEED LINK,” filed on Mar. 15, 2013, which is hereby incorporated by reference herein.

### BACKGROUND

In information theory and coding theory with applications in various fields, including computer science and telecommunication, error detection and correction (or error control) can be viewed as techniques that enable reliable delivery of digital data over unreliable mediums (e.g., communication channels). For example, many communication channels are subject to channel noise, and thus errors may be introduced during transmission from the source to a receiver. Error detection techniques allow detecting such errors, while error correction enables reconstruction of the original data.

To provide an example, one error-detecting code commonly used in digital networks and storage devices for detecting accidental changes to raw data is widely known as cyclic redundancy check (CRC). Typically, in using CRC, blocks of data get a short check value attached, based on the remainder of a polynomial division of their contents. On retrieval of the data, the calculation is repeated, and corrective action can be taken against presumed data corruption if the check values do not match. The check (data verification) value is a redundancy (it expands the message without adding information) and the CRC algorithm can be based on cyclic codes. CRCs are popular because they are simple to implement in binary hardware, easy to analyze mathematically, and particularly good at detecting common errors caused by noise in transmission channels. Because the check value has a fixed length, the function that generates it is occasionally used as a hash function. The CRC was invented by W. Wesley Peterson in 1961. The 32-bit CRC function of Ethernet and many other standards is the work of several researchers and was published during 1975. Today, the most commonly used polynomial lengths are: 9 bits (CRC-8), 17 bits (CRC-16), 33 bits (CRC-32) and 65 bits (CRC-64).

As is widely known in the art, error correction and recovery of transmission data are very useful with applications extending in various fields, including computer science and telecommunication.

### SUMMARY

Broadly speaking, the invention relates to computing environments and systems. More particularly, the invention relates to techniques for error detection and recovery for computing environments and systems.

In accordance with one aspect, errors that can be detected as a result of the mapping of transmission data from its physical form back to its logical form can be considered in addition to the errors detected by using an error detection technique (e.g., a conventional CRC technique), thereby allowing fewer error detection/recovery bits (error recovery data or bits) to be used as would be possible by using the error detection technique alone. In other words, less error recovery data would be needed to achieve a given level accuracy using conventional techniques. As a result, overhead associated with adding error detection/recovery bits can be reduced.

By way of example, a CRC8 error detection technique can be used in combination with a Running Disparity (RD) and a Bad10B check in connection with mapping the physical data back to logical data in accordance with embodiment. As a result, an accuracy in line with CRC32 can be achieved without having to incur the cost associated with adding additional (32−8=24) bits of data.

In accordance with another aspect, error recovery can be achieved when errors are detected as a result of the mapping of data from a physical form to its logical form in addition to using an error detection technique requiring the addition of error recovery bits. In doing so, messages detected to be in error can be simply retransmitted. By way of example, a Retransmission Interface (RTX) can be provided to allow for a “clean” recovery in accordance with embodiment.

Other aspects and advantages will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 depicts a computing environment 100 with a sender 102 and a receiver 104 in accordance with one embodiment.

FIG. 2 FIG. 2 depicts a method 200 for transmission of data based on a desired level of accuracy for the transmission of data from a sender to a receiver in accordance with one embodiment.

FIG. 3 depicts a method 300 detecting error in transmission of data sent by a sender to a receiver in accordance with one embodiment.

FIGS. 4A-B depict errors in a 10-bit space and resulting induced errors in a corresponding 8-bit space.

FIG. 5 depicts an exemplary 120-bit data word 502 with its appropriate 8-bit CRC8 504, together forming a 128-bit link-layer message in accordance with one embodiment.

FIG. 6 depicts a Message Code Space M and a Transmission Code Space T in accordance with embodiment.

FIG. 7 depicts a retransmission (RTX) interface 700 in accordance with an embodiment.

### DETAILED DESCRIPTION

As noted in the background section, error correction and recovery are very useful with applications extending in various fields, including computer science and telecommunication.

As an example, a cyclic redundancy check (CRC) can be used to detect and correct errors, for example, in data transmitted from a sender to receiver. However, there is a significant cost associated with using CRC. Moreover, the cost increases as more accuracy is desired to effectively detect virtually all errors and correct them. For example, more accuracy can be achieved by using (CRC-64) instead of (CRC-8) but this means having to add about 64 bits of redundant data to the actual data of interest instead of having to add just about 8 bits of redundant data if CRC-8 is used.

The redundant data can be especially problematic for some applications, where, for example, relatively shorter messages are exchanged over a network. However, virtually all applications could benefit if data accuracy can be achieved with relatively less cost (or overhead).

In view of the foregoing, improved error detection and correction techniques are needed and would be highly useful.

As such, it will be appreciated that improved error detection and correction techniques can be provided at least by considering errors that can be detected as a result of the mapping of transmission data from its physical form back to its logical form in addition to the errors detected by using an error detection technique (e.g., a conventional CRC technique), thereby allowing fewer error detection/recovery bits (error recovery data or bits) to be used as would be possible by using the error detection technique alone. In other words, less error recovery data would be needed to achieve a given level accuracy using conventional techniques. As a result, overhead associated with adding error detection/recovery bits can be reduced.

By way of example, a CRC8 error detection technique can be used in combination with a Running Disparity (RD) and a Bad10B check in connection with mapping the physical data back to logical data in accordance with embodiment. As a result, an accuracy in line with CRC32 can be achieved without having to incur the cost associated with adding additional (32−8=24) bits of data.

In accordance with another aspect, error recovery can be achieved when errors are detected as a result of the mapping of data from a physical form to its logical form in addition to using an error detection technique requiring the addition of error recovery bits. In doing so, messages detected to be in error can be simply retransmitted. By way of example, a Retransmission Interface (RTX) can be provided to allow for a “clean” recovery in accordance with embodiment.

Embodiments of these aspects of the invention are also discussed below with reference to FIGS. 1-7. However, those skilled in the art will readily appreciate that the detailed description given herein with respect to these figures is for explanatory purposes as the invention extends beyond these limited embodiments.

FIG. 1 depicts a computing environment 100 with a sender 102 and a receiver 104 in accordance with one embodiment. Referring to FIG. 1, the sender 102 sends the data (or logical data) 106 to the receiver 104 based or in consideration of a desired accuracy rate 108 for the transmission of the data 106 (e.g., 99.75% accuracy rate). In doing so, the sender 102 initially coverts or maps the data (or logical data) 106 to physical data (PD) 112 for transmission as the transmission data 114. In addition, the sender 102 adds or inserts into the transmission data, error detection/recovery data (ERD) 116 for facilitating error recovery detection by the receiver 104 that can be configured to receive the transmission (or transmitted) data 114. It should be noted that there is a need to map between a physical form (physical data 112) and a logical form (data or logical data 106). Technically, all of the transmission data 114 can be considered to be physical data when it is on a link. Also, the error detection/recovery data (ERD) 116 can considered to be in a physical form of an ERD which may or may not have a logical interpretation. In some embodiments, it has a logical origin, meaning it is and can be computed and analyzed in the logical domain. Typically, mapping of the logical data 106 to physical data is performed in order to transmit the data 106 from the sender 102 to the receiver 104. Also, as those skilled in the art will readily know, one or more additional bits (error recovery bits) can be used for detection of errors and for facilitating error recovery using one or more conventional error recovery techniques. The error recovery bits can be included or effectively embedded in the transmission data 114. As such, the transmission data 114 can include physical data 112 for the data 106, as well as error detection/recovery data (ERD) 116 that can be provided as one or more error detection/recovery bits (or “error recovery bits”).

Referring to FIG. 1, it will be appreciated that a “reduced” number of error recovering bits can be used as error detection/recovery data (ERD) 116 in accordance with one aspect of the invention. In this context, a “reduced” number of error recovering bits can refer to the number of bits that are less than the number of error recovery bits needed to achieve a desired accuracy rate 108 for transmission of data. To further elaborate, the sender 102 can use an error detection/recovery technique (“error recovery technique”) with a reduced number of error recovery bits (e.g., 8 bits used for error recovery where 32 bits may be needed to achieve a desired level of accuracy 108). Although using a reduced number of error recovery bits in itself (or alone) may not yield the desired accuracy rate 108, it will be appreciated that other activities at the receiving side of the transmission (typically performed by the receiver 104 itself) can be utilized to achieve an overall accuracy rate for the transmission of the transmission data 114. As such, the overall accuracy rate can be higher than the accuracy rate associated with using the error recovery technique alone. As will be described in greater detail below, in accordance with one aspect, one such activity that can be performed at a receiving side (e.g., receiver 104) of a transmission is the mapping of the physical data (e.g., physical data 112) of transmission data (e.g., transmission data 114) back to its logical form (e.g., the data or logical data 104).

By way of example, a CRC8 technique can be used as an error recovery technique with a “reduced” number of bits (8 bits) used for error recovery even though the desired accuracy rate 108 calls for more bits to be used (“full number of bits”) in order to achieve the desired accuracy. In the example, the accuracy rate associated with a CRC8 recovery technique may not be in line with a desired accuracy rate 108 that may, for example, correspond with a CRC32 error recovery technique that uses 32 bits instead of the 8 bits used by the CRC8 technique. Nevertheless, it will be appreciated that the sender 102 would be able to use an error recovery technique with a reduced number of error recovery bits provided activities at the receiver side of the transmission are also used to enhance the overall accuracy rate beyond what could be achieved by only relying on the error recovery technique with a reduced number of error recovery bits. By way of example, in one embodiment, the receiver 104 can use a Running Disparity (RD) and a Bad10B check in connection with mapping of the physical data 112 back to data (or logical data) 106, as those skilled in the art will appreciate.

Referring back to FIG. 1, the receiver 104, in addition to using the reduced number of error recovery bits associated with an error recovery technique that can detect a number of errors or number of bits in error (e1), can also detect errors (e2) in the transmission data 114 as received by the receiver 104, in the process of mapping the physical data 112 back to the data (or logical data) 106. Moreover, the receiver 104 can send back to the sender 102 an indication 121 that indicates all of the errors detected (e1+e2) that may include additional errors (e2) not detected by the error recovery technique alone, thereby achieving an overall accuracy rate that is significantly higher than the accuracy rate that can be achieved by only using the recovery technique with the reduced number of error recovery bits.

In effect, better accuracy rates can be achieved by utilizing one or more activities that typically need to be performed at a receiver side during the course of receiving transmitted data and effectively “decoding” it to obtain the data (or logical) data.

This also means that the data can be transmitted in a more efficient manner since a lower number of error recovery bits are utilized, for example, resulting in more compact messages and/or less data traffic, while still achieving an accuracy rate that are at least close to a desired accuracy rate and generally acceptable, especially given the efficiency in using relatively less recovery bits.

Referring to FIG. 1, the sender 102 can effectively resend or retransmit that data as indicated by the receiver 104 to be in error to allow for error recovery. In doing so, the sender 102 can, for example, buffer the data 106 in a buffer 120 in case there is a need to retransmit the data 106. Generally, data 104 and its transmission as transmission data 114 can be tracked so that at least a portion of the data 104 can be retransmitted to the receiver 104 when that transmission of that portion of the data 104 is determined to be in error.

FIG. 2 depicts a method 200 for transmission of data based on a desired level of accuracy for the transmission of data from a sender to a receiver in accordance with one embodiment. Method 200 can, for example, be performed by the sender 102 to transmit data to the receiver 104 (shown in FIG. 1). Referring to FIG. 2, initially, data is mapped (202) to physical data for transmission by a sender to a receiver. It should be noted that at least some of the error detection code can be originated prior to the mapping (202) of the physical data. After the mapping (202), transmission data is generated (204) by using an error detection technique (e.g., a CRC technique) with a reduced number of error recovery bits added to the physical data for error detection. It should be noted that the reduced number of bits can be less than a full number of bits that would be required to achieve a desired level of accuracy for the transmission by using the same error detection technique. This can be achieved by considering or utilizing the error detection capabilities associated with the mapping of the of the physical data of the transmission data back to logical data. As such, referring back to FIG. 2, optionally, it can further be determined (206) to take corrective action when errors are detected. As such, it can optionally be determined (208) whether an error indication is received as a result of mapping the physical data back to its logical form (logical data). The indication can, for example, indicate and identify that one or more bits are in error. The indication can be sent by a receiver as a result of mapping of the physical back to logical data. If it is determined (208) that an indication has been received, one or more bits of the data in the transmission data determined to be in error, as a result of mapping the physical data back to its logical form, can be resend.

To elaborate even further, FIG. 3 depicts a method 300 detecting error in transmission of data sent by a sender to a receiver in accordance with one embodiment. Method 300 can, for example, be performed by the receiver 104 to detect errors in transmission data 114 sent by the sender 102 (shown in FIG. 1). It should be noted that the transmission data can be generated by using an error detection technique (CRC) with a reduced number of error recovery bits for error detection added to physical data obtained by mapping the data to physical data for the transmission in accordance with one embodiment. For example, the transmission data can be generated by using the method 200 depicted in FIG. 2. It should be noted that the CRC can often be computed on the logical data. Consequently, the act of mapping from logical (including CRC) to physical data can indirectly provide one or more benefits, including: the physical-to-logical conversion (at receiver) PLUS interpretation of the logical CRC (reduced number of bits), can be used together to provide a higher level of protection than the CRC alone could provide. As those skilled in the art will appreciate there is no need to limit these activities to logical CRC or physical CRC.

Referring to FIG. 3, in effect, the method 300 can wait (302) for transmission data to be received. It should be noted that the transmission data can be received in a physical form. If it is determined (302) that transmission data has been received, the physical data is mapped backed (304) to logical data. It should be noted that errors can be interpreted in the logical domain after the conversion. This may include interpreting purely physical errors since that domain may be significant. In other words, the combination of errors can be combined to provide protection. Thereafter, at least partly based on the mapping of the physical to logical data (in addition to as purely physical errors), it is determined (306) whether an error in transmission data has been detected in the transmission data. Consequently, if it is determined (306) at least partly based on the mapping of the physical to logical data, that an error has been detected in the transmission data, at least a portion of the transmission data determined (306) to be in error can be identified (308). Optionally, retransmission of the at least one portion of data in error can be requested (312) if it is determined (310) to do so. The method 300 can proceed to detect errors in transmission data received in a similar manner as discussed above until it is determined (314) to end receiving the transmission data, for example, as a result of input and/or system shutdown.

FIG. 4A depicts an error in a 10-bit space and its resulting induced error in a corresponding 8-bit space. Referring to FIG. 4A, a 5-bit flurry of errors in the 10-bit space can effectively induce both bytes (16 bits) to be in error in the corresponding 8-bit space, as those skilled in the art will know. Moreover, those skilled in the art will readily appreciate that the a 5-bit flurry error can be detected, for example, by using a combination of CRC8, RD and Bad10B protection in accordance with one embodiment.

FIG. 4B depicts another error in a 10-bit space and its resulting induced error in a corresponding 8-bit space. Referring to FIG. 4B, a combination of CRC8, RD and Bad10B protection can be used to detect 10-bit random error windows in accordance with another embodiment. It should be noted that many other random error windows beyond 5-bit can be detected as well even though not shown in FIGS. 4A or 4B.

A combination of CRC8, RD and Bad10B protection can, for example, be provided in or as a link layer as those skilled in the art will appreciate. In the example, the maximum overhead associated with providing CRC8 protection can be about 6-9% of the data. In addition, typically CRC8 can be provided in a transparent manner with a little packing.

FIG. 5 depicts an exemplary 120-bit data word 502 with its appropriate 8-bit CRC8 504, together forming a 128-bit link-layer message in accordance with one embodiment. Referring to FIG. 5, substantially similar error protection can be achieved at about the 6.25% of the cost (overhead) of that which conventionally would be required. Similarly, a 96-bit link-layer message is depicted (88 data bits) in FIG. 2, providing an overhead of about 8.3% of the conventional techniques.

Furthermore, it should be noted 1×8n symbols can be covered directly. 2×8B symbols can be covered in combination with RD+Bad10b, for up to a 5-bit 10 b error flurry. For 128-bit the following polynomials can provide relatively safe and very cost-effective protection for 128 and 96 bits relatively: x⁸+x⁶+x³+x²+1, and x⁸+x⁵+x³+x²+x+1. Those skilled in the art will also appreciate that protection against error can, for example, be provided in one embodiment as: BER ˜O (10̂−17) that can yield: ˜O (10̂−28), where O (10̂−26)/system or better, for example, can be treated as an independent statistical event with greater than 98% confidence (no undetected error would occur over many hundreds of thousands of systems for more than a decade).

Furthermore, error correction can be provided, for example, with a relatively simple software-assisted retransmission in accordance with one embodiment. Generally, as long as an error is detected, the error is correctable.

For example, a retransmission layer can be provided in or as a layer two (2) where it can utilize a relatively light-weight credit transfer (effectively like level one and half (1.5)). In this context, chatter at about one microsecond of granularity can be sufficient, where it is possible to piggyback on the higher layer credit traffic but also capable of transmission independently.

As a general approach, when an error is detected, hardware can be effectively induced to “freeze” precisely. Software and/or hardware can be used to effectively lock down the hardware, determine any deficits precisely, and realign the hardware to begin again. Implementations can be relatively simple and they could, for example, assume a JTAG TAP access if a software approach to retransmission is taken. In the context of the Join Test Action Group, JTAG TAP is generally known a low-level, common hardware device interface which can be used as a “backdoor” access to a device even when all other interfaces are in a questionable state. It can a relatively safe but relatively slow path.

FIG. 6 depicts a Message Code Space M and a Transmission Code Space T in accordance with embodiment. Referring to FIG. 6, with respect to Injective mappings M T (n, each with inverse) the following can be noted:

(i) Fi maps elements from M to subset ti of T (1<=i<=n),

(ii) Fi−1 maps elements from ti of T “back” to M,

(iii )Zero or more admissible codes may exist in T which do not

Map to any element of M but may be used as, e.g., control signals, and

(iv) Zero or more inadmissible codes may exist which are virtually never used (and should virtually never be received).

Referring again to FIG. 6, with respect to error detection, one or more mutations of received messages belonging to T-Transition from one element of T to another, and presence of inadmissible codes, should be noted.

Also, referring again to FIG. 6, with respect to construction of detection codes the following features should be noted: (i) comprised of string of at least one element of M-could go smaller than one element, (ii) detect one or more error conditions (mutations of received messages belonging to T) with desired confidence level, and (iii) transmitted virtually at any time (temporal independence).

FIG. 7 depicts a retransmission (RTX) interface 700 in accordance with an embodiment. Referring to FIG. 7, RTX, RXC, TXC, and RTC are exemplary components of a recovery (correction) system. Data for transmission and possible retransmission are stored in RTX, where message ordering may or may not be preserved, though order preservation in the face of link errors is the more sophisticated requirement. Units RXC, TXC, and RTC offer a correction mechanism which can preserve order, both during normal transmission and correction.

In FIG. 7, A and B are opposite ends of a logical or physical link, having full duplex transmit and receive capabilities. A's RXC unit listens for and records delivery confirmations transmitted from receiving link B, information used to deduce and adjust A's transmitter storage, particularly storage for data which may need to be retransmitted in the course of corrective action. A's RTC observes data received from B and prepares confirmations to be returned to B, where A.TXC records those confirmations which have been, minimally, ‘put on the link’ to B—though not necessarily received by B successfully. In one realization, the recovery process involves exchanging these data between A and B and accounting for any discrepancies, either by means of SW or HW intelligence, so as to retransmit any lost data from A to B and B to A, before resuming normal transmission. However, it should be noted that the protocol does not require a physical point-to-point link between A and B, as the intervening connectivity could be comprised of any network or communication devices and interconnects which relay, switch, route, etc., data or control messages among devices.

Referring to FIG. 7, the RTX interface 700 can effectively admit by a remote management agent (i.e., SW) such that (i) interaction is sustained over “long” distances (spatial and temporal), (ii) data integrity of high-speed transmissions is preserved (no loss of data and no creation of data not transmitted), (iii) link may be returned to a functional state, requiring no more corrective action or interaction, until such time as a next error detected, (iv) additional information (e.g. additional error occurrences) provided which may be considered in evaluating overall link “health” and its “fitness” to continue operating (e.g. HW link replacement determination). In addition, one or more hardware (HW) function implementations which substitute for actions of a remote management agent may be included, providing speed of recovery.

Referring to FIG. 7, the following provides in greater detail an exemplary implementation in accordance with one exemplary embodiment. Specifically, upon Soft/Hard error detection at A RX, HW will (immediately or simultaneously) enter A RX drop mode (dropping all inbound traffic), freeze A.RTC and A.RTX (all A transmit); and Assert interrupt for A RX ERROR. Upon receiving an interrupt, software (SW) if not already performed by HW, will enter B RX drop mode; and freeze B.RTC and B.RTX (all B transmit). SW will clear pending interrupts for A RX ERROR and B RX ERROR, i.e., SW implicitly coalesces any B RX ERROR interrupt and operates on both sides of link, and HW will continue to detect and assert any & all RX ERROR (Soft/Hard). SW then will: (i) A.RTC+=A.TXC-B.RXC (modulo size), (ii) B.RTC+=B.TXC-A.RXC (modulo size), (iii) clear A.TXC, A.RXC, B.TXC, and B.RXC, (iv) restore A RX and B RX mode to normal (exit drop mode), (iv) unfreeze A.RTC and B.RTC, (v) realign A.RTX and B.RTX (each one command to HW), (vi) unfreeze A.RTX and B.RTX, and (vii) recheck A RX ERROR and B RX ERROR.

Referring to FIG. 7, the following can be stated from the perspective of A, where B (remote) will progress in parallel, accordingly & interchangeably: (i) SRLZ_TIME˜>1 us, (ii) entire process should be SW watchdogged to˜>10*SRLZ _TIME from receiving interrupt—exceeding this could be fatal, as is LINK_RTX_ABORT, (iii) LINK_RTX_BEGIN is a distinct LL packet, LINK_RTX_DATA, LINK_RTX_SYNC and LINK_RTX_RESUME could be merged into a single logical LL form, all distinct from LL commit credits, (iv) any LINK_RTX_ABORT triggered during LINK_RTX is logged exit state, (v) SW should monitor progress upon receiving interrupt (which may reduce to checking for final state, once possible). Upon Soft/Hard error detection or receipt of LINK_RTX, can BEGIN packet at A RX, where HW will (immediately, simultaneously): (i) enter A RX drop mode (dropping all inbound traffic), (ii) freeze A.RTC and A.RTX (all A transmit), (iii) assert interrupt for A RX ERROR, (iv) transmit 1 LINK_RTX_BEGIN packet to B. Then, HW will (i) pause for SRLZ_TIME, and (ii) restore A RX mode to normal (exit drop mode). Any detection of Soft/Hard error from here to the completion of LINK_RTX sequence (return to Protected Operational Mode) can trigger LINK_RTX_ABORT. Consequently, HW A TX transmits LINK_RTX_DATA continuously-A.LINK_RTX_DATA={A.TXC, A.RXC}. Upon receiving LINK_RTX_DATA packet from B: HW will (i) Transmit 1 last LINK_RTX_DATA (disregarding further RX), (ii) A.RTC+=A.TXC-B.RXC (modulo size), and (iii) clear A.TXC, A.RXC. Upon receiving LINK_RTX SYNC packet from B: HW will (i) Unfreeze A.RTC, and (ii) once A.RTC==0, transmit 1 LINK_RTX_RESUME packet to B. Upon receiving LINK_RTX_RESUME packet from B: (i) HW will realign A.RTX, and (ii) Unfreeze A.RTX. As result: (i) LINK_RTX complete & successful Protected Operational Mode can be achieved, (ii) Unless LINK_RTX_ABORT in which case the link can be deemed unstable beyond BER.

It should also be noted that error correction can be done by using executable code (software), for example, as JTAG TAP complaint code. Also, one to multiple (as well as one to many) management of links can be achieved in parallel, for example, by using a remote manager or agent provided as a software component.

Generally, various aspects, features, embodiments or implementations of the invention described above can be used alone or in various combinations. Furthermore, implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, an apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile or near-tactile input.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described is this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of transmission of data based on a desired level of accuracy for the transmission of data from a sender to a receiver, wherein the method is implemented at least partly by a device, and wherein the method comprises:
mapping the data to physical data for transmission by the sender to the receiver; and
generating transmission data at least by using an error detection technique with a reduced number of error bits that are added to the physical data for error detection and/or recovery, wherein the reduced number of error bits is less than a full number of error bits that would be required to achieve the desired level of accuracy for the transmission of the transmission by using the same error detection technique.

2. The method of claim 1, wherein the method further comprises:
receiving an indication that one or more bits of the data in the transmission data are in error as a result of mapping the physical data of the transmission data back to the data, wherein the one or more bits of data in error are not detected as a result of using the error detection technique with the reduced number of error recovery bits.

3. The method of claim 2, wherein the method further comprises:
resending to the receiver the one or more bits of the data in the transmission data indicated by the indication to be in error.

4. The method of claim 3, wherein the method further comprises:
storing and/or maintaining at least a portion of the transmitted data after sending the transmission data to allow resending the transmission data.

5. The method of claim 1, wherein the error detection technique is a CRC error detection technique.

6. The method of claim 5, wherein the error detection technique is a CRC8 error detection technique, and wherein the desired level of accuracy for the transmission is achievable by using a CRC32 error detection technique.

7. The method of claim 1, wherein a Running Disparity (RD) technique and a Bad10B technique are used in connection with mapping the physical data back to logical data in order to detect errors in the transmission data.

8. A method of detecting errors in transmission data sent by a sender to a receiver, wherein the transmission data is generated by using an error detection technique with a reduced number of error bits added to physical data obtained by mapping logical data to the physical data for transmission of the transmission data, wherein the reduced number of error bits is less than a full number of error bits that would be required to achieve a desired level of accuracy, wherein the method is implemented as least partly by a device, and wherein the method comprises:
determining as a result of the mapping of the physical data of the transmission data back to the logical data that at least a portion of the data in the transmission data is in error, thereby achieving an overall accuracy for the transmission of the data that is at least close to the desired level of accuracy and higher than the accuracy that can be achieved by using only the error detection technique with the reduced number of error bits.

9. The method of claim 8, wherein the method further comprises:
sending an indication that indicates that the at least one portion of the data in the transmission data determined to be in error.

10. The method of claim 8, wherein the method further comprises:
sending a request for retransmission of the at least one portion of the data in the transmission data determined to be in error.

11. The method of claim 1, wherein the method further comprises: Order-preserving correction by retransmission.

12. A device that includes one or more processors configured to transmit data based on a desired level of accuracy for the transmission of data from a sender to a receiver, wherein the one or more processors are further configured to:
map the data to physical data for transmission by the sender to the receiver; and
generate transmission data at least by using an error detection technique with a reduced number of error bits that are added to the physical data for error detection and/or recovery, wherein the reduced number of error bits is less than a full number of error bits that would be required to achieve the desired level of accuracy for the transmission of the transmission by using the same error detection technique.

13. The device of claim 12, wherein the one or more processors are further configured to allow error correction by using executable code.

14. The device of claim 13, wherein the executable code is provided as JTAG TAP complaint code.

15. The device of claim 13, wherein the one or more processors are further configured to enabling one to multiple management of links.

16. The device of claim 15, where the one or more processors are further configured to support and/or provide a manager that performs the error correction the one to multiple management of links in parallel.

17. A non-transitory computer readable storage medium storing at least executable code for transmission of data based on a desired level of accuracy for the transmission of data from a sender to a receiver, wherein the executable code when executed:
maps the data to physical data for transmission by the sender to the receiver; and
generates transmission data at least by using an error detection technique with a reduced number of error bits that are added to the physical data for error detection and/or recovery, wherein the reduced number of error bits is less than a full number of error bits that would be required to achieve the desired level of accuracy for the transmission of the transmission by using the same error detection technique.
